(19) United States
(12) Patent Application Publication
(10) Pub. No.: US 2025/0002293 A1
(43) Pub. Date: Jan. 2, 2025

(54) SYSTEM FOR CABLES, CABLE SPOOL AND CRADLE

(71) Applicant: ONETIDE MODULAR SYSTEMS PTY LTD, Perth, WA (AU)

(72) Inventor: Roy MITCHELL, Perth, WA (AU)

(21) Appl. No.: 18/693,127

(22) PCT Filed: Sep. 16, 2021
(86) PCT No.: PCT/AU2021/051074

§ 371 Date: Mar. 18, 2024

(30) Foreign Application Priority Data
Sep. 16, 2020 (AU) 2020903315
Aug. 25, 2021 (AU) 2021221788

(51) Int. Cl. B65H 75/42; B65H 75/44; H02G 9/02; H02G 9/12; H02G 11/02

(52) U.S. Cl. CPC B65H 75/425; B65H 75/4489; H02G 9/02; H02G 9/12; H02G 11/02

(57) ABSTRACT

A system and method for storing, deploying and retracting cables, wherein the cables are those used to connect a docked ship with onshore facilities, such as water, electricity, and telecommunications. The system comprises one or more of a cable spool, a cradle and a support for moving and managing the cable spool. The system enabling the relatively rapid deployment and retraction of cables with minimal personnel compared to prior art systems.

### FIELD

Generally the present invention relates a system for handling cables. In particular the present invention relates to a cable spool, a cradle for handling the cable spool, and a system for storing and deploying cables including high energy cables, and hoses, including flat hoses.

### BACKGROUND

High energy cables are deployed on a temporary basis, for example when a ship docks to connect the ship to a land electricity grid while the ship is docked so as to supply power to the docked ship. Such cables may be transported with the ship so that dependency on infrastructure is not created, or they may be made available at the ship dock. In any case, usually there is no permanent cable installed on a wharf. The lengths of such temporary cables are usually quite long, so as to reach from the docked ship to a connection point of the grid.

When deployed, and typically when stored, the cable is exposed to UV radiation and the elements (including salt water). Accordingly it is desirable for the cables to be stored when not in use to minimise exposure of the cable for only as long as needed so as to prolong the life of the cable.

Currently, such cables are stored in a basket and deployed using many people (see FIGS. 1, 2a, and 2b) to remove one end of the cable from the basket and to extend the cable from the basket. This is labour intensive and is quite time consuming to deploy.

Additionally, it is desirable to have the basket as small as possible to hold the necessary length of cable. The cables have a certain thickness to carry the necessary current. Due to this, the cables have a minimum curve radius (maximum amount of bend) for the cable to satisfy manufacturer requirements and ensure maximum service life. When coiled in the baskets the cables are often bent to a curve radius less than the minimum specified curve radius-thereby negatively affecting the service life of the cable.

Alternatively, the cables are left on the wharf exposing them to environmental conditions, potentially reducing their service life.

Commonly three cables are deployed to provide three phase power, or single phase AC power with Active, Neutral and Earth conductors.

Current techniques can take up to 4 hours to deploy one cable. Deploying three cables can take up to 12 hours.

In other applications, hoses are often required to be laid temporarily to deliver fuel to aircraft. In military applications, aircraft landing zones are set up for safe landing and take-off. These landing zones are typically temporary and remote from fuel stores. Currently, the fuel is trucked from the fuel store, which is dangerous and time consuming.

The preceding discussion of the background art is intended to facilitate an understanding of the present invention only. The discussion is not an acknowledgement or admission that any of the material referred to is or was part of the common general knowledge as at the priority date of the application.

### SUMMARY OF THE INVENTION

It is an object of this invention to provide a system for storing and deploying cables which ameliorates, mitigates or overcomes, at least one disadvantage of the prior art, or which will at least provide the public with a practical choice.

It is a preferable object of this invention to provide a cable spool which ameliorates, mitigates or overcomes, at least one disadvantage of the prior art, or which will at least provide the public with a practical choice.

It is a preferable object of this invention to provide a support base for supporting a cable spool which ameliorates, mitigates or overcomes, at least one disadvantage of the prior art, or which will at least provide the public with a practical choice.

Throughout the specification the term ‘cable’ is used to describe a cable, a hose, a flat hose or any other similar flexible conduit may be used to assist in transmitting services such as water, fuel, electricity or telecommunication signals. Furthermore the term ‘cable’ can denote a single unitary cable, or a cable made from a number of cables.

According to a further aspect of the present invention there is provided a system to deploy and retract at least one cable, the system comprises:
a cable spool for deploying and receiving the at least one cable therearound, a cradle which is adapted to be mounted to a vehicle, such as a forklift, the cradle is adapted to releasably support the cable spool, the cradle comprising a drive means to selectively rotate the cable spool,
wherein rotation of the cable spool in a first direction deploys the at least one cable from the spool, and rotation of the cable spool in a second direction enables retraction of the at least one cable on to the spool.

According to a further aspect of the present invention there is provided a system to deploy and retract at least one cable, wherein the at least one cable connects a docked ship with onshore facilities, the system comprises:
a cable spool for deploying and receiving the at least one cable therearound, a cradle which is adapted to be mounted to a vehicle, such as a forklift, the cradle is adapted to releasably support the cable spool, the cradle comprising a drive means to selectively rotate the cable spool,
wherein rotation of the cable spool in a first direction deploys the at least one cable from the spool, and rotation of the cable spool in a second direction facilities retraction of the at least one cable on to the spool.

According to a further aspect of the present invention there is provided a system to deploy and retract the at least one cable, wherein the at least one cable connects an aircraft with a fuel store, the system comprises:
a cable spool for deploying and receiving the at least one cable therearound, a cradle which is adapted to be mounted to a vehicle, such as a forklift, the cradle is adapted to releasably support the cable spool, the cradle comprising a drive means to selectively rotate the cable spool,
wherein rotation of the cable spool in a first direction deploys the at least one cable from the spool, and rotation of the cable spool in a second direction facilities retraction of the at least one cable on to the spool.

According to a further aspect of the present invention there is provided a system to deploy at least one cable on the seabed, the system comprises:
a cable spool for deploying the at least one cable therefrom, a cradle which is adapted to be towed behind a vessel, the cradle is adapted to releasably support the cable spool, the cradle comprising a drive means to selectively rotate the cable spool,
wherein rotation of the cable spool in a first direction deploys the at least one cable from the spool.

The cable spool may be adapted to rotate in the opposite direction to retract the cable from the seabed.

The cable spool may be made from buoyant materials. The cable spool may have buoyancy devices secured thereto.

The cradle may be made from buoyant materials. The cradle may have buoyancy devices secured thereto.

The cable spool may be adapted to be used for a variety of cables, simultaneously and selectively. The cable spool may be divided into sections along its axis for different cables.

Preferably the cable spool comprises:
a support surface upon which the at least one cable is received, the diameter of the support surface being adjustable to accommodate different cable types;
two sidewalls between which the support surface extends.

Preferably each sidewall has one or more slots formed therein. Stiffening members may be fitted to the slots to add rigidity to the cable spool.

The slots may accommodate shrinkage and expansion of the sidewall.

The support surface may be provided by a plurality of elongate support members extending between the two sidewalls. Preferably there are at least eight elongate support members.

The sidewalls may support the support members at predetermined radial positions from the spool's central axis, wherein the support surface may be adjusted to different diameters to accommodate different cables. In this regard the cable spool can be adjusted so that the support surface is at a diameter whereupon the cable may be wound an stored in a manner which meets the recommended radius of curvature for that cable, therefore prolonging its service life.

The elongate support members may be spaced from adjacent elongate support members to define a hollow central core, wherein a first end of a cable may be received in the hollow central core defined by the elongate support members, before the cable is wound thereon.

The sidewalls may be in the form of a polygon. This allows for ease of storage and ensures the cable spool is not able to roll. The sidewalls may have mounting means to allow spools to be stacked thereon. The sidewall may have tie down means to secure cable spools together.

The cable spool may support a variety of cables including: flat fuel hoses; round hoses; large shore power sized cables; electrical cables; fence wire.

The cable spool may have buoyancy means to ensure the cable spool floats if it falls into a body of water.

The drive means may be in the form of a hydraulic motor.

The hydraulic motor may be directly coupled to the cable spool when the cable spool is supported by the cradle. The drive means can be readily disconnected to allow removal of the spool from the cradle.

The cable spool may be made from lightweight, corrosion resistant materials.

According to a further aspect of the present invention there is provided a cradle adapted to releasably secure a cable spool as herein described;

According to an aspect of the present invention there is provided a cradle support for receiving and supporting a cable spool, such as one herein described, the cradle support comprising:
at least two arms between which the cable spool may span, each arm having a locking means at its end, each locking means movable between an open condition wherein the cable spool may be received thereon, and a closed position wherein the cable spool is locked relative to the cradle arm;
a power system adapted to engage the spool for rotation thereof, the power system being removable attached to an end of one of the arms; a cradle mount adapted to be received on a vehicle such as a fork lift.

According to an aspect of the present invention there is provided a cable spool adapted for repeatable winding on and off of at least one cable; the cable spool comprises:
a support surface upon which the at least one cable is received, the diameter of the support surface being adjustable to accommodate different cable types;
two sidewalls between which the support surface extends;
each sidewall having slots formed therein, wherein stiffening members may be fitted to the slots to add rigidity to the cable spool.

According to an aspect of the present invention there is provided a support base for supporting a cable spool such as the cable spool herein described, the support base comprises stabilising means which are retractable and may be extended when a cable spool is supported on the support base. The support base may be disassembled into a relatively flat package. The support base may have mounting means which may be received on complementary mounting means on a truck (such as those similar to for mounting shipping containers.)

According to an aspect of the present invention there is provided a method for deploying cable between a ship and onshore services, the method comprises:
securing a cable spool having the required cable stored thereon to a cradle support, wherein the cradle support is secured to a lifting vehicle, such as a forklift;
connecting one end to a ship coupling, or placing the one end adjacent the ship;
powering a motor on the cradle support to cause the spool to rotate;
moving the vehicle to lay the cable adjacent the dock;
connecting the other end of the cable to the onshore services.

According to an aspect of the present invention there is provided a method for retracting a cable which extends between a ship and onshore services, the method comprises:
securing an empty cable spool to a cradle support, the cable spool having the support surface set at the desired diameter for the cable to be received thereon,
placing or securing one end of the cable relative to a hollow core of the cable spool;
powering a motor on the cradle support to cause the spool to rotate and to start winding on the cable;
moving the vehicle to continue to wind on the cable which is adjacent the dock;
securing the other end of the cable relative to the spool;
storing the cable spool with cable for future use.

According to a further aspect of the present invention there is provided a cable spool comprising an axial shaft; spaced apart radially extending side walls; at least one support surface radially spaced from the shaft and extending substantially parallel to the shaft between the sidewalls, wherein the radial distance of the at least one support surface from the axial shaft can be varied, whereby in use, cable is wound on to the support surface.

The cable can therefore be wound onto the spool so as to have a radius of curvature of at least the radial spacing between the surface and the shaft.

In an embodiment the at least one support surface comprises a plurality of spaced apart longitudinally elongate members.

In an embodiment the spool comprises an axle portion projecting from each side wall. In an embodiment the shaft forms the axle portions.

In an embodiment the side walls are hexagonal in shape.

In an embodiment the side walls are formed of a high density polyethylene, preferably UHDPE.

In an embodiment the radial distance of the elongate members is variable and/or adjustable. In an embodiment the sidewalls comprise radially extending slots each for receiving an end portion of the elongate member so as to allow the radial position to be adjusted. In an alternate embodiment the end portions of the members comprise a fixing means for fixing the radial position of the end of the member within apertures formed in the sidewall.

According to another aspect of the present invention there is an assembly comprising a cradle for lifting the spool so that the shaft is substantially horizontal, the cradle comprising support means for releasably receiving and supporting the shaft of the cable spool.

In an embodiment the cradle comprises a mounting mechanism for attachment to a vehicle.

In an embodiment the cradle comprises a motor for rotating the spool so as to wind cable onto or off the cable spool. In an embodiment the motor is coupled to the shaft for rotating the cable spool.

In an embodiment the motor is a hydraulic motor. In an embodiment the hydraulic motor is powered by a hydraulic circuit of the vehicle.

According to a further aspect of the present invention there is provided a method of deploying a cable comprising providing the cable wound onto a spool; lifting the spool with a cradle; unwinding the cable from the spool using a motor mounted to the cradle; and moving the spool as the cable is unwound.

In an embodiment there are a plurality of cables wound on the spool. Preferably as the spool is unwound the cables unwind and are deployed in parallel.

According to a further aspect of the present invention there is provided a method of storing a cable comprising lifting a spool with a cradle; winding the cable onto the spool using a motor mounted to the cradle; and moving the spool as the cable is wound onto the spool.

According to an aspect of the present invention there is provided a system and method for deploying and retracting cables, wherein the cables are those used to connect a docked ship with onshore facilities, such as water, electricity, and telecommunications, the system comprises a cable spool, a cradle and a support for moving and managing the cable spool, the system enabling the relatively rapid deployment and retraction of cables with minimal personnel compared to prior art systems.

According to a further aspect of the present invention there is provided a system and method for deploying and retracting cables, wherein the cables are used to transport fuel to an aircraft landing zone, the system comprises a cable spool, a cradle and a support for moving and managing the cable spool, the system enabling the relatively rapid deployment and retraction of cables with minimal personnel compared to prior art systems.

According to a further aspect of the present invention there is provided a system and method for deploying and retracting cables on the seabed, wherein the system comprises a cable spool, a cradle and a vessel for moving and managing the cable spool, the system enabling the relatively rapid deployment and retraction of cables with minimal personnel compared to prior art systems.

In an embodiment there are a plurality of cables wound on to the spool in parallel. Those may be wound on/off the cable spool at the same time.

### DESCRIPTION OF DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which::

FIG. 1 is a side elevation of a prior art basket stored cable being positioned;

FIG. 2a is a side elevation of prior art deployment of the cable from the basket of FIG. 1.

FIG. 2b is a side elevation of a prior art storage of the cable back into the basket;

FIG. 3 is an end elevation of a cable spool assembly supported by a cradle according to an embodiment of the present invention;

FIG. 4 is a cross-sectional view through a centre line of a cable spool portion of the assembly of FIG. 3;

FIG. 5 is an elevation of a hub of the spool portion of FIG. 3;

FIG. 6 is an elevation of an axle of the spool portion of FIG. 3;

FIG. 7 is an elevation of an alternative axle of the spool portion of FIG. 3;

FIG. 8 is an end view of a cross-section of the axle of FIG. 6/7 showing a spider ring;

FIG. 9 is a side elevation of alternative vehicles and a cradle for holding the spool portion of the assembly of FIG. 3;

FIG. 10 is an end elevation of an alternative embodiment of a spool portion;

FIG. 11 is a side elevation of the spool portion of FIG. 10 in a partial exploded view;

FIG. 12 is a side elevation of the spool assembly of FIG. 3 showing a motor in an engaged position;

FIG. 13 is a side elevation of the spool assembly of FIG. 12 showing the motor in a disengaged position;

FIG. 14 is an end view of the spool portion of FIG. 3 schematically shown within an intermodal shipping container;

FIG. 15 is a side elevation of three spool portions of FIG. 3 end to end schematically shown within an intermodal shipping container;

FIG. 16 is a photo of a spool assembly according to an embodiment of the present invention;

FIG. 17 is a photo of a cradle of the spool assembly of FIG. 16 coupled to a vehicle;

FIG. 18 is a photo of a spool portion disengaged from the cradle of the assembly of FIG. 16;

FIG. 19 is a schematic diagram showing deployment of a cable from the spool assembly in a ship to shore application;

FIG. 20 is a side view of a cable spool according to a further embodiment of the present invention;

FIG. 21 is a front view of the cable spool of FIG. 20 wherein the support surface is set at a first diameter;

FIG. 22 is a front view of the cable spool of FIG. 20 wherein the support surface is set at a second diameter;

FIG. 23 is a view of a cable spool according to an embodiment supported in cradle arms according to an embodiment;

FIG. 24 is a close up view of FIG. 23 showing one side of the cradle arm supporting one side of the cable spool, the arm also supporting a motor to rotate the spool.

FIG. 25 is a side view of an end of an arm of the cradle support of FIG. 23 wherein the end is in a locked position, such would be the case when a cable spool was supported thereon;

FIG. 26 is a side view of an end of an arm of the cradle support of FIG. 23 wherein the end is in a unlocked position, such would be the case when a cable spool is to be received thereon;

FIG. 27 is a schematic diagram showing deployment of a cable from the spool assembly in a marine application; and

FIG. 28 is a plan view of the cable spool and cradle of FIG. 27.

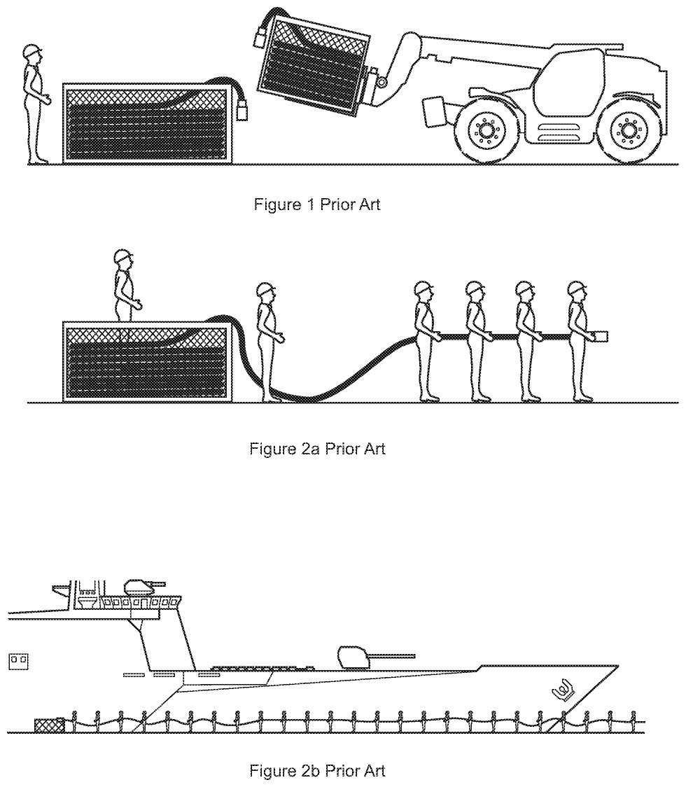

In the drawings like structures are referred to by like numerals throughout the various views and embodiments.

### EMBODIMENTS OF THE INVENTION

Generally the present invention provides a system for handling and storing cables, such as those suited for providing utilities to a docked ship, those laid on the seabed or hoses, such as flat hoses, being used to deliver fuel. In particular the present invention relates to a cable spool, a cradle for handling the cable spool, and a system for storing and deploying cables including high energy cables, and hoses, including flat hoses.

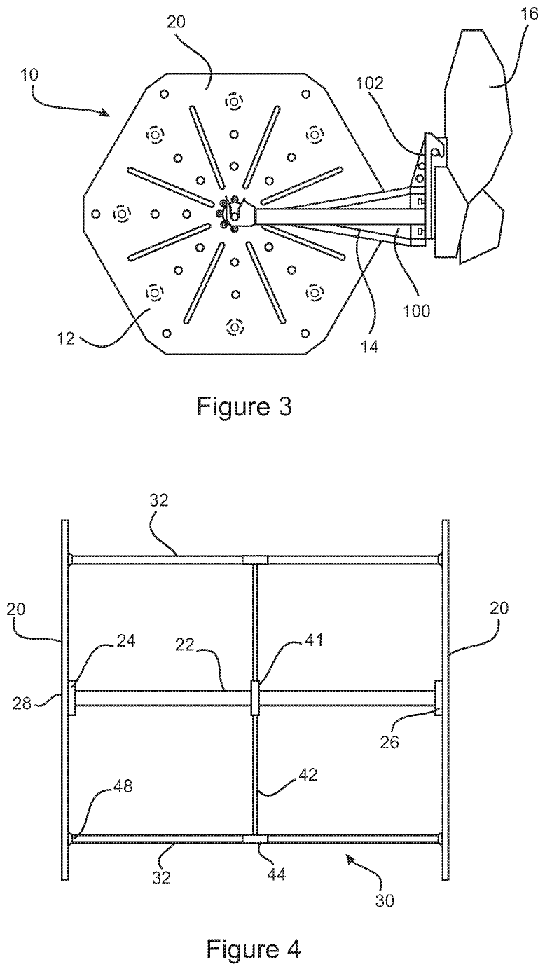

Referring to FIG. 3 there is shown a cable spool assembly 10 comprising a spool portion 12 (spool) and a cradle 14 for attachment to a mounting point 16 of a vehicle 150. The spool 12 comprises spaced a part sidewalls 20, preferably hexagonal in shape (although other shapes are possible such as a circle, pentagon, heptagon, an octagon, or other polygon). The sidewalls 20 are preferably formed of a corrosion resistance light weight material, such as a thermoplastic, preferably polyethylene (PE), more preferably a high density PE (HDPE) and most preferably ultra-high density PE (UHDPE).

As seen in FIG. 4 the sidewalls 20 are connected by an axially extending shaft 22, and a plurality of elongate support members in the form of bars 32 forming a plurality of contact surfaces 30 on which the cable 95 is supported when wound on the spool 12. The shaft may be a single light weight member. The shaft 22 may be in the form of a steel tube. The bars 32 are substantially parallel to and radially spaced from the shaft 22.

In an embodiment the axle comprises a connector ring 41 for connecting radially extending support struts (spiders) 42. The bars 32 are connected to the side walls 20 by a connector 48 at each end. In other embodiments the spool 12 does not require the connector ring or struts.

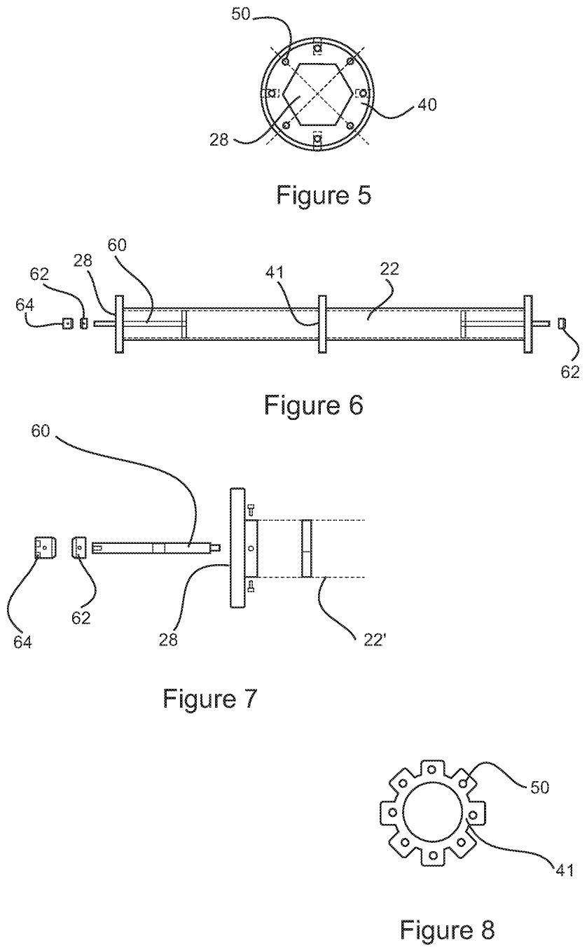

At each end 24, 26 of the shaft 22 is a hub 40, as shown in FIG. 5. The hub 40 is connected to the sidewall 20 by fasteners extending through holes 50. The hub 40 may also have a hole 28 therethrough, and through the sidewall 20.

In the embodiment, the shaft 22 in FIG. 6 has a stub axle 60 in the form of a shaft welded to or otherwise fixed thereto which passes through the hole 28. The stub axle 60 has a centring ring 62 at each end. One end (the left one in FIG. 6) also has a drive hub 64 fixed to it such that a drive means, such as a motor, can be coupled to the drive hub 64 which in turn can rotate the shaft 22 and thus rotate the spool 12 about the axis coinciding with the shaft 22.

In the embodiment of FIG. 7, the stub axle 60 is releasable so as to be replaceable.

FIG. 8 shows the connector ring 41 having holes through which fasteners can connect the connector to the spiders 42.

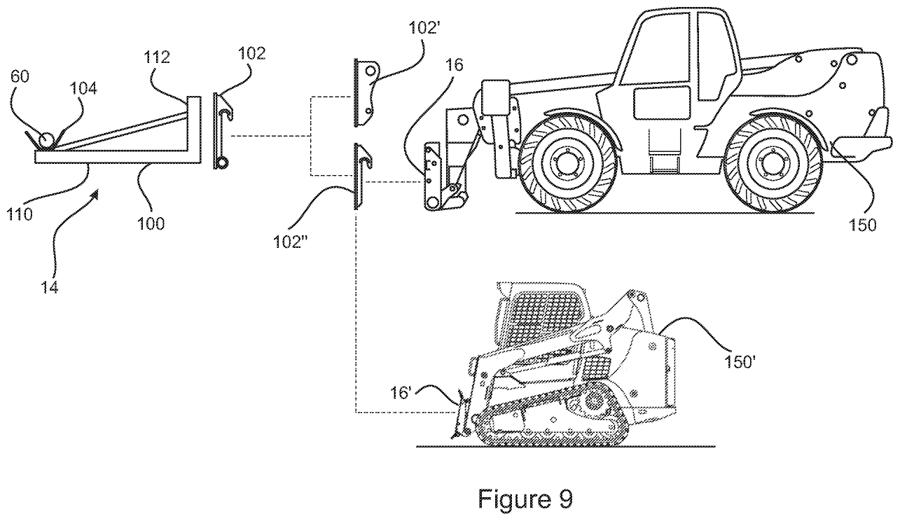

FIG. 9 shows the cradle 14, which comprises side supports 100 and a backplate 112 connecting the side supports 100. Opposite the backplate 112 at the end of each side support 100 is a receiver 104, generally V shaped, for the shaft 22 of the spool 12 to be received thereon so as to support the spool 12. The centring rings 62 keep the spool 12 centred on the cradle 14.

The underside 110 of the side supports 100 may rest on the ground or on a transport/work stand (not shown).

The backplate 112 may be reinforced with, or formed from beams. On the opposite side of the backplate to the spool 12 a pair of adaptors 102 can be bolted hereon. The adaptors 102 are made suitable for the mounting point 16 of the vehicle 150 to be used. It can be seen in FIG. 9 that there are three types of adaptor 102, 102′ and 102″, with two different types of mounting point 16, 16′ for the respective vehicles 150, 150′. In alternative embodiments the adaptor may be formed to suit a number of different mounting arrangements/vehicles. In other embodiment the adaptor is a universal adaptor and is integral with the backplate 112.

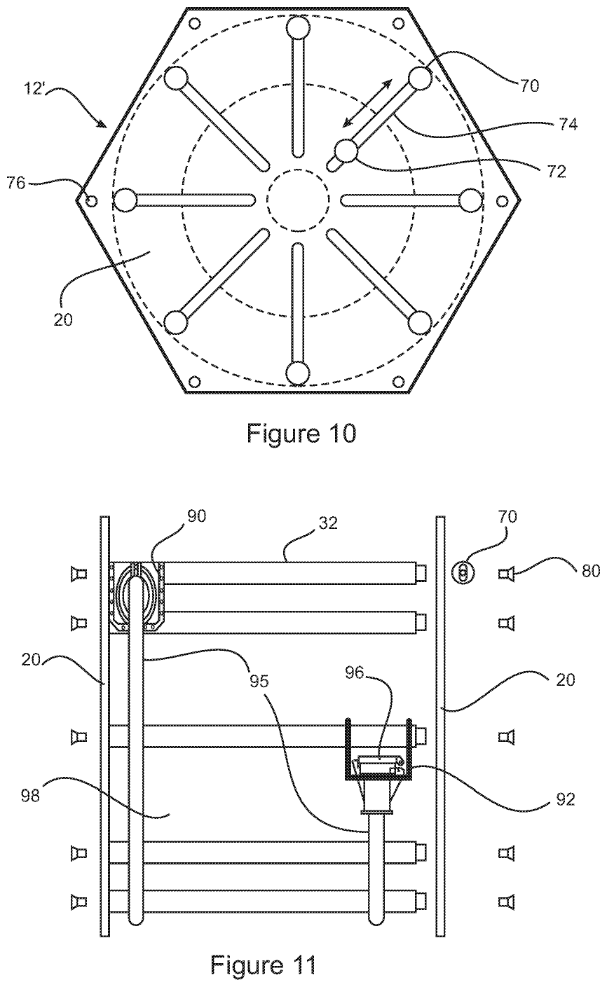

FIGS. 10 and 11 show an embodiment of the spool 12′ with adjustable bars 32. In this embodiment the sidewalls 20 have radially extending slots 74 in which ends 70 of each bar 32 can slide until tightened to secure the ends 70 in position within the slots 74 using fastener 80. As an alternative to slots, fixed position holes can be used, as shown for example in FIG. 16.

In can be seen the ends 70 of the bars 32 can be moved inwardly to position 72. This can be done on both ends of the bars 32 for each of the bars 32 so that the radius of the contact surface 30 provides by the bars 32 can be varied to accommodate the characteristics of the cable being wound on (in terms of permitted bending radius and length).

As shown in FIG. 11, the cable 95 has a connector housing 96 at one end (for securing to another cable or equipment). When first winding the cable 95 onto the spool the connector housing 96 may be received within a central hollow core 98 of the spool 12, the core 98 being defined by the bars 32. This ensures the cable 95 is able to be uniformly received on the spool 12. The connector housing 96 may be releasable secured to a receiving means such as a hanger 92. The receiving means is secured to the central shaft 22. In alternative embodiments the receiving means may be in the form of a spigot or finger like structure, wherein the spigot is received in the connector housing 96 to hold it in place. The spigot may be releasably secured to the central shaft 22. The receiving means may be in the form of a series of spigots being of different diameters and/or at different angles, allowing a variety of different cables to be wound onto the spool 12.

As also shown in FIG. 11, the connector housing 96 at the other end of the cable 95 may be releasably secured relative to the spool when the cable 95 is wound thereon with the use of a hammock/basket 90. This will ensure the cable 95 does not begin to unwind from the spool 12 and minimises damaging the connector housing 96. The hammock 90 is secured around/to the connector housing 96 and secured to the bars 32.

It can be seen that the side walls 20 have holes 76 to assist in lifting or securing the spool 12.

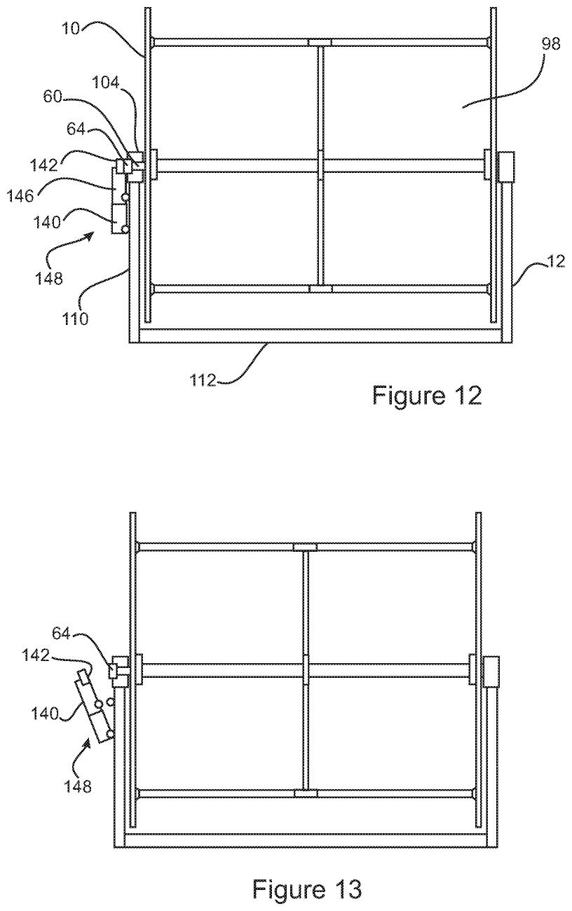

FIGS. 12 and 13 show a drive means in the form of a motor assembly 148 comprising a motor 140 connected by a gear box 146 to a coupling 142. The coupling couples the output of the gearbox 142 to the drive hub 64 so as to drive the shaft 22 and this the spool 12 to rotate about its axis. With this arrangement the motor is directly coupled to the spool 12. The spool 12 is able to be rotated in both directions. In alternative embodiments the motor 140 may be electric instead of hydraulic.

As seen in FIG. 13 the motor assembly 148 is able to be pivoted so as to de-couple the coupling 142 from the drive hub 64 when the spool 12 is to be removed from the cradle 14.

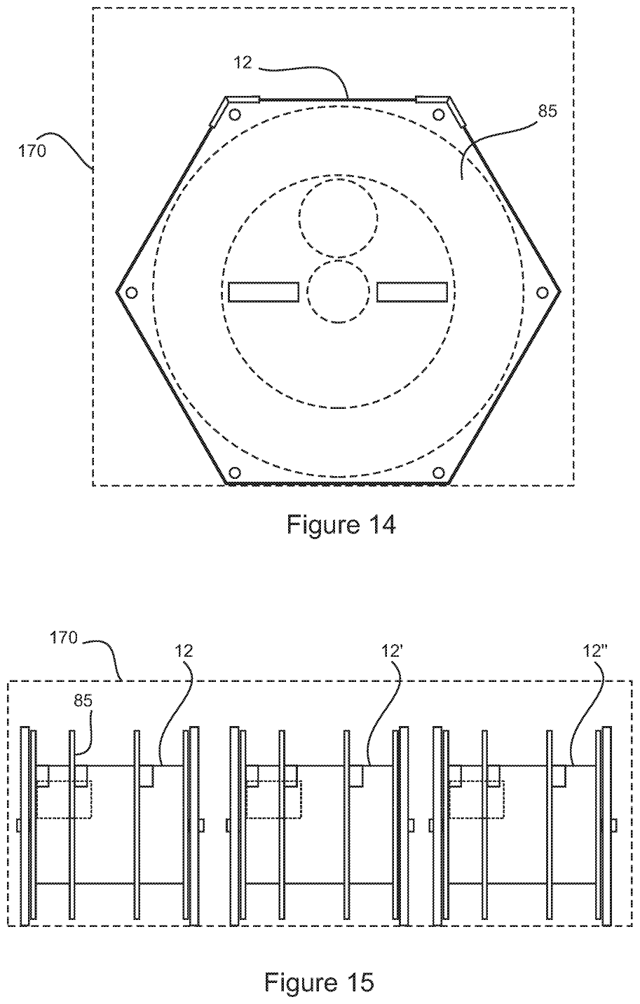

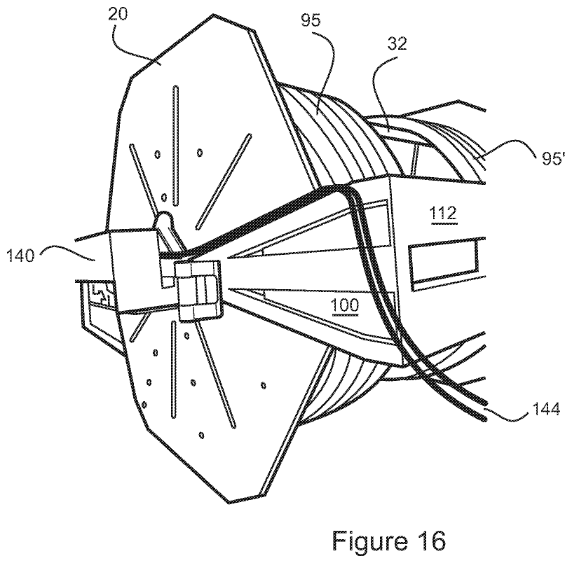

FIGS. 14 and 15 show that the spool 12 is preferably dimensioned to fit within the width and height of an shipping container 170 and is of an axial length so that three spools 12, 12′, 12″ can fit end to end within the length of a standard 20 foot intermodal shipping container.

Also shown are dividers 85 which can divide the length of the shaft 22 into sections for different cables.

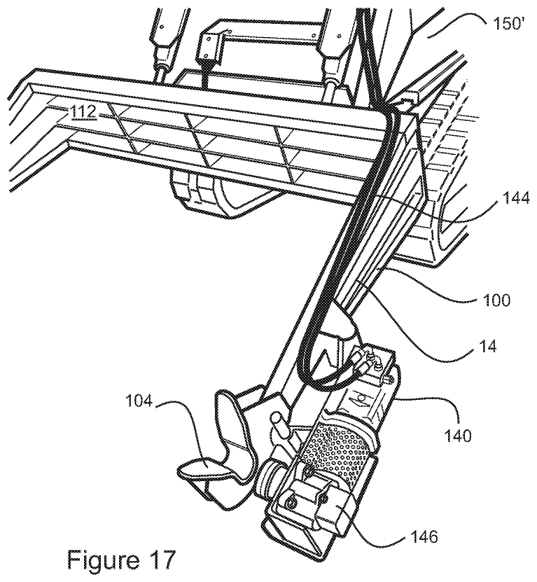

FIGS. 16 to 18 show photos of a further embodiment of the spool 12 and cradle 14. Hydraulic lines 144 for the motor (in the form of a hydraulic pump) 140 are shown for connection to a hydraulic power supply of the vehicle 150′. The hydraulic pump 140 may be provided with a flow control to control the speed of rotation of the spool 12.

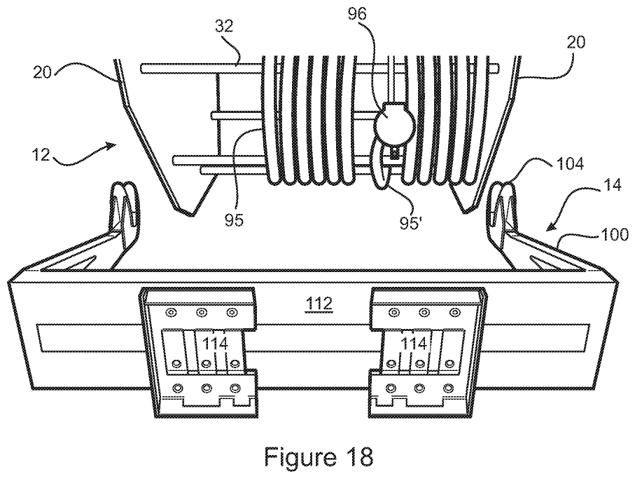

In FIG. 18 the adaptors include mounting panels 114 for mounting the backplate 112 to the adaptors 102. In alternative embodiments the mounting panes 114 provide the adaptors 102

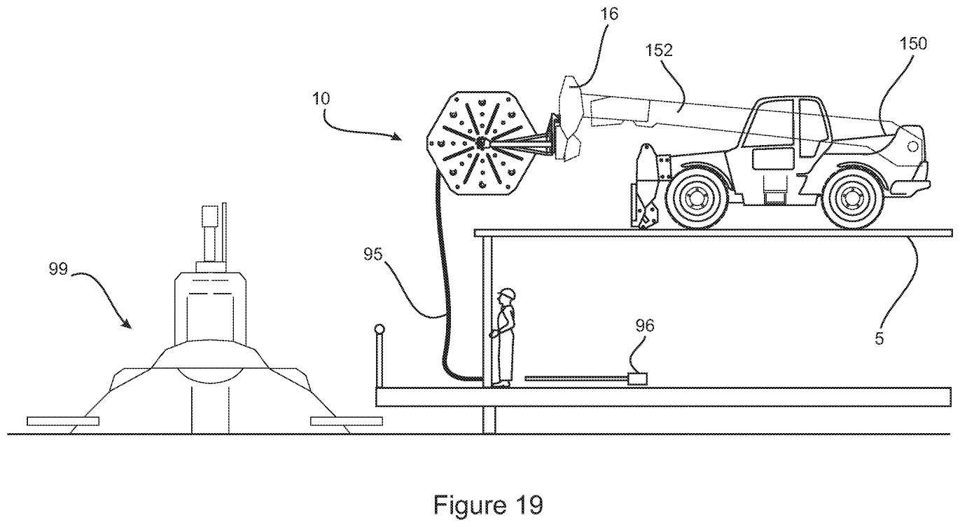

FIG. 19 shows a method of employing the spool assembly 10 to deploy a cable 95 to a marine vessel (in this case a submarine 99). The spool 12 is lifted via the cradle 14 to a deployment position. The motor is activated to unwind the free end of the cable 95 having connector 96 (once it is unhooked) so there is enough slack in the cable. A drop deck deployment as illustrated can be accommodated, or a rise can also be accommodated by using a crane or lifting arms of the vehicle 150. The vehicle 150 can then continue to unwind the cable 95 from the spool 12 as it moves (in this case backwards) down the wharf. Once unwound and at the desired position the cradle 14 can be lowered to release the spool 12 from the cradle 14. The spool can be rested on the ground 5. The other end of the cable can then be connected to the utilities on shore.

As seen in FIGS. 16 and 18 a plurality of cables 95, 95′ are wound onto the spool 12. As the spool is unwound the cables 95, 95′ are unwound in parallel. This is particularly advantageous when more than one cable is required to be deployed to enable different services to be connected, such as in ship to shore applications.

The cable(s) 95, 95′ can also be retracted and stored by picking up the spool with the cradle 14 and the motor can rotate the spool 12 so as to wind the cable 95 on to it. The vehicle 150 can move along as the cable is be wound so as to not drag it on the ground 5. When fully wound on, the connector 96 can be hooked on thereby securing the cable in place and the spool 12 can then be moved to a storage place.

The cradle 14 is attachable and detachable from the vehicle 150 similar to the manner in which any tool would ordinarily be attached to the mounting point 16 of the vehicle 150 such as by use of the adaptor 102.

The present invention allows for storage of the cable in a manner less prone to damage and allows for rapid deployment, retraction and storage of the cable with minimal manpower (about 2 people) than currently used techniques.

For most applications the spool weights is about 570 kg unloaded and about 1.6 tonne when loaded with a 100 m high energy 72 mm diameter cable. The spool 12 can carry three 30 m cables, or one 100 m cable. Where the cable is in the form of a flat fuel hose, the spool may support 1 km of flat hose. Typically the diameter of the contact surface around which the cable is wound can be positioned at 0.5 to 1.8 m. However, the spool can be scaled upward or downward depending on the required application.

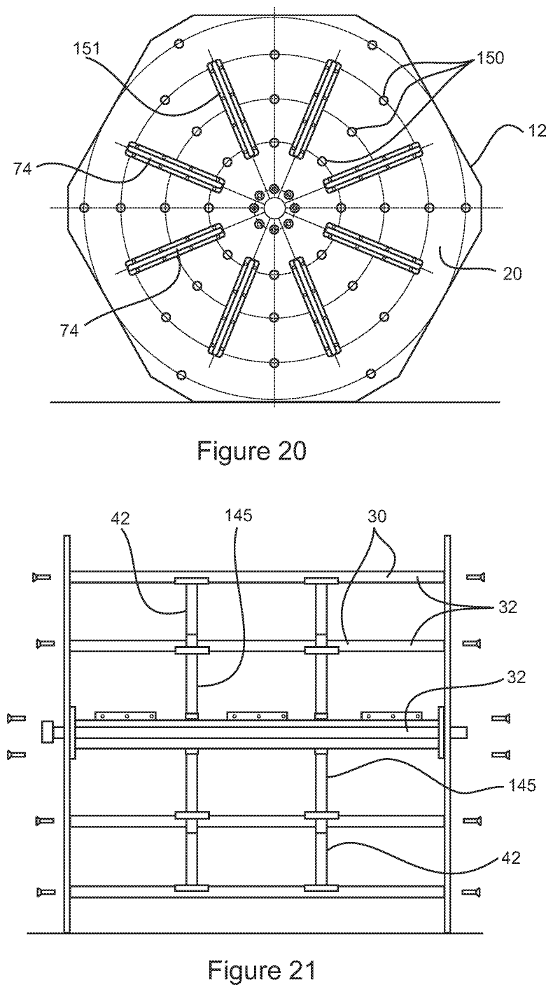

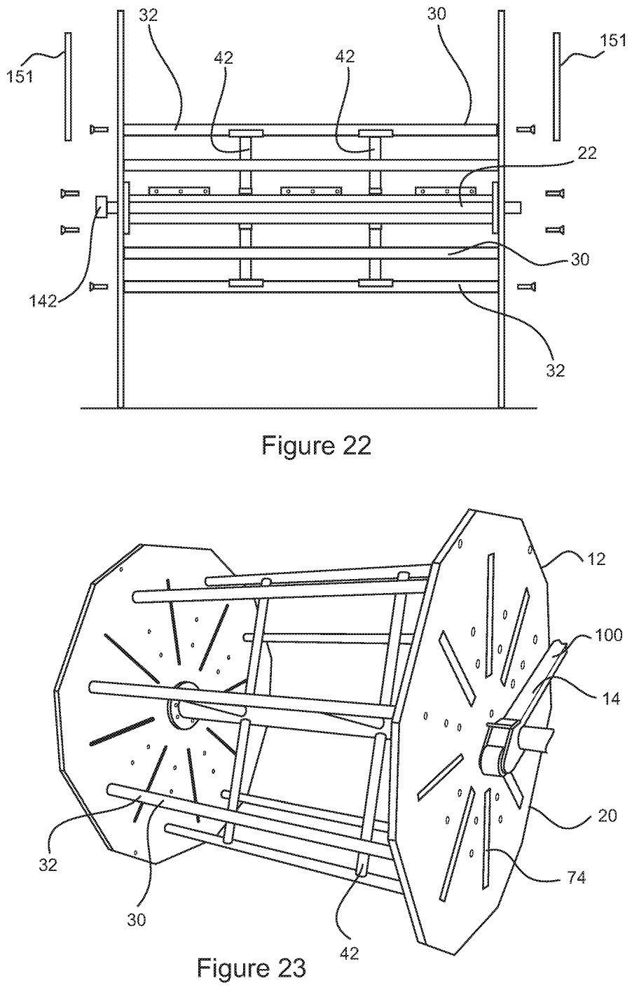

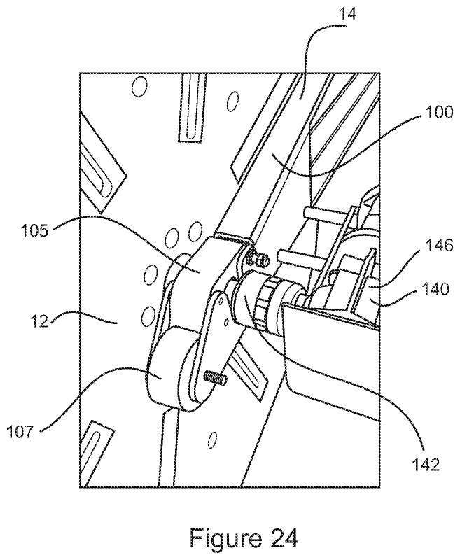

FIG. 20 shows a spool 12 according to a further embodiment wherein the sidewall 20 of the spool provides a plurality of sets of apertures 150, in this case three, wherein each set of apertures is at a different radii to the other sets. The apertures are adapted to support the ends of the bars 32, whereby the bars may be fixed relative to the set of apertures 150 which will ensure the contact surface 30 is at the required diameter as dictated by the type of cable 95 to be wound thereon. For cables which are required to be stored at a large radius, the contact surface 30 provided by the bars 32 is as shown in FIG. 21. While for those cables in which the radius can be small, such as flexible hoses, the contact surface 30 provided by the bars 32 is as shown in FIG. 22.

To increase the strength of the spool, a stiffener member 151 can be fitted to one or more of the slots 74 in the sidewall.

To further add strength to the spool, the spool includes two sets of support struts 42 extending between the central shaft 22 and one or more bars 32. The support struts 42 may include an extender 145 for when the contact surface is set at a large radius, such as shown in FIG. 21.

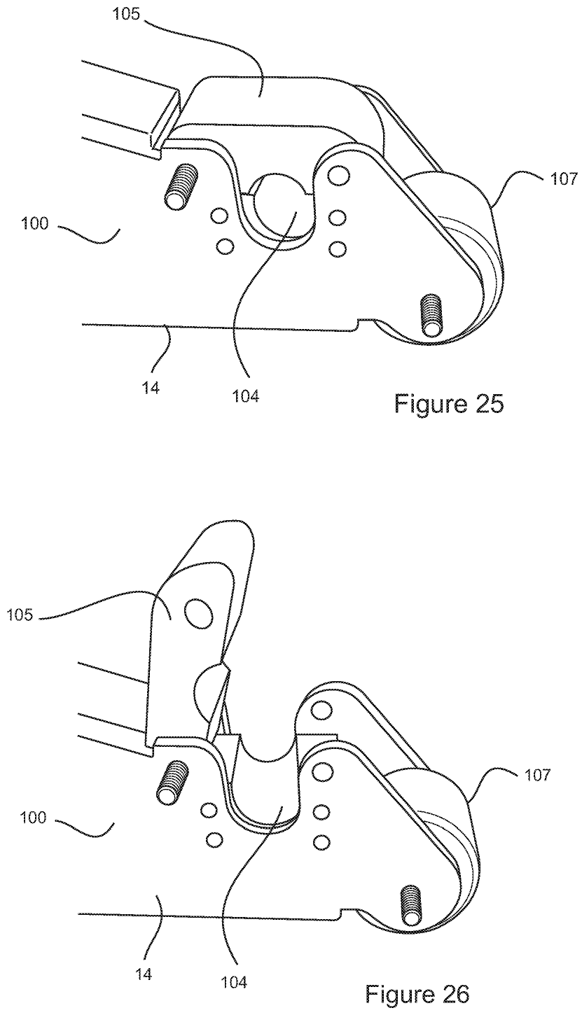

When the spool 12 is received on the cradle, the side supports 100 of the cradle 14 provide means to releasably lock the spool 12 to the cradle 14. As shown in FIGS. 25 and 26, the receiving sections 104 provide a closure 105 which is pivotally mounted with respect to the receiving sections 104. Once the spool 12 is supported on the receiving section 104 of the cradle 14, the closure 105 may be rotated to close the receiving section 104 to retain the spool 12 in position.

Each end of the side supports 100 support a wheel 107 located at each end to assist in maneuvering and protecting the ends of the cradle 14.

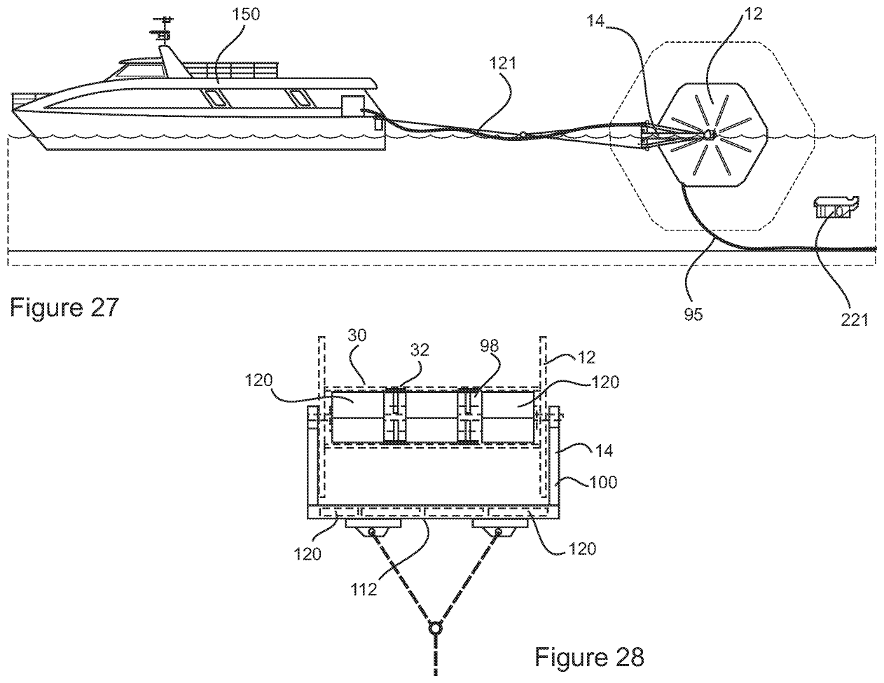

In a further application, an embodiment of the present invention is adapted to lay cable along the seabed. As shown in FIGS. 27 and 28, the spool 12 has buoyancy devices 120 fitted in its core 98. In addition the cradle 14 has buoyancy devices 120 fitted to the back plate 112. In addition, the spool is made from non-metallic material which provides buoyancy. In this embodiment the power means is provided on the towing vessel 150, and has an umbilical cord 121 extending back to the spool 12 to rotate same. As the vessel 150 moves forward, the spool 14 is caused to rotate to deploy the cable along the seabed. An ROV 221 may be used to monitor the deployment. To retract the cable a revers operation takes place.

The dotted outline around the spool 12 in FIG. 27 represents that the spool can be scaled to allow for deployment of longer cable lengths.

The spool 12 may also accommodate hoses (for fresh water, fuel).

The spool 12 able to be disassembled into a ‘flat pack’ format for transport. Ship to ship and ship to shore deployment is possible.

Advantages of the present invention over the prior art include:
owing to its design, the material selected can be light weight and corrosion resistance.
mechanical means to adjust support surface diameter, eliminating unnecessary complexity, maintenance, weight and cost;
direct drive of spool with multiple drive hub options;
adjustable spider supports enables different types of cables to be supported thereon;
core is isolated from electrical shock via thermoplastic sides and spider support nubbins;
connector/cable end support hammock/hanger;
multipurpose slots inside walls: stiffener; adjustable (flush mounted) tie down point; enables spool to be used in carousel mode.
spool is multi-mode capable: flat fuel hose 8, 6 and 4″); normal round hose various sizes; large shore power sized cables; smaller electrical cables; wire;
ability to capture and secure the end connectors of the cable via universal capture device (hammock/hanger/spigots)
hexagonal shaped sides for stability when free standing;
spools designed to be stacked on top of each other;
flat pack design for optimised transport (when cable not supported thereon);
components, including central shaft, are removable and replaceable when required;
floatation devices can be fitted thereto: for use at sea, or can be salvaged if unintentionally falls into a body of water;
designed to be relatively low weight (mass) permits helicopter under sling capability;
   designed to be relatively low weight enables spools to be utilised on smaller sized machines. Modifications and variations such as would be apparent to the skilled addressee are considered to fall within the scope of the present invention. The present invention is not to be limited in scope by any of the specific embodiments described herein. These embodiments are intended for the purpose of exemplification only. Functionally equivalent products, formulations and methods are clearly within the scope of the invention as described herein. It will be understood by those skilled in the art that various changes in form and details may be made therein without departing from the spirit and scope of the invention as defined by the appended claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Such variations are not to be regarded as a departure from the disclosure, and all such modifications are intended to be included within the scope of the disclosure.

The method steps, processes, and operations described herein are not to be construed as necessarily requiring their performance in the particular order discussed or illustrated, unless specifically identified as an order of performance. It is also to be understood that additional or alternative steps may be employed.

Reference to positional descriptions and spatially relative terms), such as “inner,” “outer,” “beneath”, “below”, “lower”, “above”, “upper” and the like, are to be taken in context of the embodiments depicted in the figures, and are not to be taken as limiting the invention to the literal interpretation of the term but rather as would be understood by the skilled addressee.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

It will be understood that when an element is referred to as being “on”, “engaged”, “connected” or “coupled” to another element/layer, it may be directly on, engaged, connected or coupled to the other element/layer or intervening elements/layers may be present. Other words used to describe the relationship between elements/layers should be interpreted in a like fashion (e.g., “between”, “adjacent”). As used herein the term “and/or” includes any and all combinations of one or more of the associated listed items.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprise”, “comprises,” “comprising,” “including,” and “having,” or variations thereof are inclusive and therefore specify the presence of stated features, integers, steps, operations, elements, and/or components, but do not preclude the presence or addition of one or more other features, integers, steps, operations, elements, components, and/or groups thereof.

1. (canceled)

2. A system to deploy and retract at least one cable, wherein the at least one cable connects a docked ship with onshore facilities, the system comprises:
a cable spool for deploying and receiving the at least one cable therearound,
a cradle which is adapted to be mounted to a means to move the cradle, the cradle is adapted to releasably support the cable spool, the cradle comprising a drive means to selectively rotate the cable spool,
wherein rotation of the cable spool in a first direction deploys the at least one cable from the spool, and rotation of the cable spool in a second direction facilities retraction of the at least one cable on to the spool.

3. (canceled)

4. (canceled)

5. (canceled)

6. (canceled)

7. (canceled)

8. (canceled)

9. (canceled)

10. The system according to claim 2 wherein the cable spool is adapted to be used for a variety of cables, simultaneously and selectively.

11. (canceled)

12. The system according to claim 2 wherein the cable spool comprises:
a support surface upon which the at least one cable is received, the diameter of the support surface being adjustable to accommodate different cable types;
two sidewalls between which the support surface extends.

13. The system according to claim 12 wherein each sidewall has one or more slots formed therein wherein stiffening members are fitted to one or more of the slots.

14. (canceled)

15. (canceled)

16. The system according to claim 12 wherein the support surface is provided by a plurality of elongate support members extending between the two sidewalls.

17. The system according to claim 16 wherein the sidewalls support the support members at predetermined radial positions from the spool's central axis, wherein the support surface can be adjusted to different diameters to accommodate different cables.

18. The system according to claim 16 wherein the elongate support members are spaced from adjacent elongate support members to define a hollow central core, wherein a first end of a cable is received in the hollow central core defined by the elongate support members, before the cable is wound thereon.

19. (canceled)

20. (canceled)

21. (canceled)

22. The system according to claim 2 wherein the drive means is in the form of a hydraulic motor wherein the hydraulic motor is directly coupled to the cable spool when the cable spool is supported by the cradle.

23. (canceled)

24. (canceled)

25. (canceled)

26. A cable spool comprising an axial shaft; two spaced apart radially extending side walls; at least one support surface radially spaced from the shaft and extending substantially parallel to the shaft between the sidewalls, wherein the radial distance of the at least one support surface from the axial shaft can be varied, whereby in use, at least one cable is wound on to the support surface.

27. The cable spool according to claim 26 wherein the at least one support surface comprises a plurality of spaced apart longitudinally elongate members.

28. (canceled)

29. The cable spool according to claim 26 wherein the side walls are hexagonal in shape and are formed of a high density polyethylene.

30. (canceled)

31. The cable spool according to claim 26 wherein the radial distance of the elongate members from the shaft is adjustable.

32. The cable spool according to claim 31 wherein the sidewalls comprise radially extending slots each for receiving an end portion of the elongate member so as to allow the radial position to be adjusted.

33. (canceled)

34. The system according to claim 2 wherein the comprises a support frame for releasably receiving and supporting the shaft of the cable spool, wherein the cradle support comprises a motor for rotating the spool so as to wind cable onto or off the cable spool, the motor is coupled to the shaft for rotating the cable spool.

35. (canceled)

36. (canceled)

37. (canceled)

38. (canceled)

39. The system according to claim 2 wherein the cradle receives and supports the cable spool, the cradle support further comprising:
at least two arms between which the cable spool spans, each arm having a locking means at its end, each locking means movable between an open condition wherein the cable spool may be received thereon, and a closed position wherein the cable spool is locked relative to the cradle arm;
a power system adapted to engage the spool for rotation thereof, the power system being removable attached to an end of one of the arms;
a cradle mount adapted to be received on a vehicle.

40. (canceled)

41. A method for deploying and retracting cable between a ship and onshore services, the deploying method comprises:
securing a cable spool having the required cable stored thereon to a cradle support, wherein the cradle support is secured to a vehicle;
connecting one end to a ship coupling, or placing the one end adjacent the ship;
powering a motor on the cradle support to cause the spool to rotate;
moving the vehicle to lay the cable adjacent the dock;
connecting the other end of the cable to the onshore services
the retracting method comprises:
securing an empty cable spool to a cradle support, the cable spool having the support surface set at the desired diameter for the cable to be received thereon, placing or securing one end of the cable relative to a hollow core of the cable spool;
powering a motor on the cradle support to cause the spool to rotate and to start winding on the cable;
moving the vehicle to continue to wind on the cable which is adjacent the dock; securing the other end of the cable relative to the spool;
storing the cable spool with cable for future use.

42. (canceled)

43. (canceled)

44. The system according to claim 2 wherein the at least one cable connects a docked ship with onshore facilities, connects an aircraft with a fuel store, or is deployed on/retracted from a seabed.
